(19) United States
(12) Patent Application Publication
(10) Pub. No.: US 2004/0064360 A1
(43) Pub. Date: Apr. 1, 2004

(54) Method and apparatus for managing resources within an organization and in a sales & marketing pipeline

(76) Inventor: Anthony F. Meggs, Melbourne, FL (US)

Correspondence Address: BAKER & HOSTETLER LLP, Washington Square, Suite 1100, 1050 Connecticut Avenue, N.W., Washington, DC, 20036, US

(21) Appl. No.: 10/662,417

(22) Filed: Sep. 16, 2003

Related U.S. Application Data
(60) Provisional application No. 60/411,292, filed on Sep. 17, 2002.

(51) Int. Cl. G06F 17/60

(52) U.S. Cl. 705/10; 705/8; 705/1

(57) ABSTRACT

A method and apparatus that includes assessing the capacity and effectiveness of sales pipelines by assigning values to a lead as it progresses through a sales pipeline. From these values, the sale forces can efficiently process, manage and regulate the flow of new leads to ensure that the leads generated are processed effectively.

### PRIORITY

This application claims priority to the provisional U.S. patent application entitled, Sales and Marketing Management Tool, filed Sep. 17, 2002, having a Ser. No. 60/411,292 the disclosure of which is hereby incorporated by reference.

### FIELD OF THE INVENTION

The present invention relates generally to tools for sales and marketing. More particularly, the present invention relates to monitoring, regulating, and balancing Marketing and Sales activities (i.e. lead generation, opportunity generation and sales generation) against the status of those activities and a desired result (quota).

### BACKGROUND OF THE INVENTION

To be successful in sales acquisitions, businesses need to generate leads and qualified opportunities (potential sales). Many companies have whole departments and discrete processes dedicated to marketing the business in an attempt to generate leads and qualify opportunities. Upon the generation of a lead or qualified opportunity, the sales department then begins to work with the lead to generate revenue.

Sales leads are given to the sales force (or internal tele-services group), which then begins to process and qualify the lead. There are a number of products in the market that are intended to aid the sales force in processing, qualifying and managing these leads to a final disposition (sale or no sale). Such products (Sales Force Automation) are computer databases that serve as a repository for the leads and opportunities. Each lead creates a separate record to which information about the lead is kept, added and/or edited. For example, if Salesman A is working on a potential lead with Company B, a database record is created for Company B. In the initial record, basic information concerning Company B is stored such as the name of the contact, address and potential sales or products that Company B is interested in acquiring.

Salesman A begins to work with the Company B in order to generate the revenue. Each time Salesman A contacts Company B, he updates the database record by inputting information into the record in order to establish some sort of documentation as to the state of the sale. Some of the comments in the record might be that the contact at Company B was called and there has been no decision to date as to whether enough money will be allocated to fund the potential sales. Salesman A will continue to interact with Company B to capture specific information and criteria that will either qualify Company B as a sales opportunity or not. Once a lead has been qualified into a sales opportunity, its status is updated and is moved into what is often called an Opportunity Manager. Opportunity Managers are used to manage all qualified business opportunities through several discrete stages called a sales process. The total number of leads, qualified opportunities and their stage status is called the sales pipeline.

A sales manager is then able to get a look at the sales pipeline of a specific business unit, product line, geographical area or individual sales person by pulling or searching for all relevant active leads and qualified opportunities in the system. A report in the above example will indicate the current status and health of a pipeline and the sales manager can know if he needs to take action with a particular sale or sales associate.

There are, however, significant drawbacks with such a system. One of the drawbacks is a free flowing of leads that is allowed to happen because marketing and sales functions are discrete processes, in most businesses, and often operate on separate systems. In other words, present systems allow leads to freely flow into the sales pipelines without any way to effectively manage or balance the flow of leads against an actual need for more leads, the capacity to work new leads, the close rates of existing leads and/or actual pipeline sales results (quota attainment). The Gartner Group and Cahners has found that there is a significant waste of marketing dollars because as much as 70% of all sales leads are never worked by the sales force. Most of this is a result of the inability of not being able to efficiently and effectively manage marketing activity and subsequent lead flows against the status and capacity of sales pipelines. Furthermore, these discrete processes and systems do not allow organizations to install “self healing” pipelines that regulate the flow of leads and lead generation activities against the attainment of quotas and business goals.

Disparate sales & marketing systems create information silos. However, these systems also create a limited visibility in these silos, which in turn greatly affects one's ability to effectively manage and balance the resources of a sales pipeline. In fact, the current marketplace of sales forces and marketing automation does not provide for the dynamic regulation of lead flows against the capacity and effectiveness of sales pipelines. This problem is further magnified with the introduction of multiple inter-enterprise relationships that focus on, indeed even specialize in, maximizing lead generation and maturing leads into qualified opportunities.

With current systems, a majority of leads are fed indiscriminately into the sales pipeline that could be very congested, under supplied or ineffective. In such a scenario, it is unlikely that the business will yield a material return on its marketing investment. This can result in meaningful leads being neglected, ignored or worked by inadequate closers, as well as not supplying the pipelines with enough leads and/or opportunities to meet quota.

The current systems force sales reps to work leads as they flow into their pipelines and at the rate they flow into pipelines. As stated above, if leads are not balanced against capacity and effectiveness of the pipelines they are being sent to, then most leads will likely be ignored, worked poorly or fail to generate enough sales to meet quota. This results in a tremendous waste of resources being funneled to the marketing department and the inability to consistently achieve business goals. Currently, systems do not allow a company or sales team to interact with the marketing department to ensure that there is a optimized flow of leads through a system.

Accordingly, it is desirable to provide a method and apparatus that enables one to manage a sales pipeline in an efficient manner. It is desirable to provide a method and apparatus that dynamically assesses the value of a pipeline based on its active leads, opportunities and influencing factors such as close rates, days to close, monetary value of sales opportunities or quota attainment. Additionally, it is desirable to provide a method and apparatus that enables one to determine whether to restrict or allow the flow of leads into the pipeline as well as where a lead should be funneled in the event that there is not enough resources to handle a lead. Such a system ensures that resources are expended in an efficient manner. Additionally, it is desirable to provide an apparatus, method and graphical interface that allows organizations to provision and dynamically replenish pipelines with a regulated flow of leads and/or opportunities by viewing, creating and editing pipelines values, their calculators, influencing factors, and regulation rules.

### SUMMARY OF THE INVENTION

The foregoing needs are met, to a great extent, by the present invention, wherein in one aspect an apparatus is provided, that in some embodiments, assigns values to leads and or opportunities as they progress through the sales pipeline. The assigned values can be based upon a number of factors. These values improve Sale's and Marketing's ability to efficiently process and manage lead flows, as they can be used to access the health, capacity and effectiveness of a sales pipeline.

In accordance with one embodiment of the present invention, a method for optimizing the productivity of a sales force includes the steps of assigning a base value to a lead and/or opportunity in a sales pipeline, assigning a stage value to the lead based upon a current stage of the lead in the sales pipeline, determining a pipeline stage value on the lead based upon the base and stage value and determining the pipeline value based upon the pipeline stage value of all lead and/or opportunities in the pipeline. This embodiment can further include the step of determining an effective pipeline value for the pipeline stage value and/or pipeline value by assessing it with an influencing factor. The influencing factor can be but not limited to such things as the estimated close percentage, days to close, actual quota attainment and the monetary value of the potential sale.

The influencing factor is assessed against the pipeline stage value and/or pipeline value by a mathematical operation such as multiplying or dividing. After the influencing is used to adjust the pipeline stage value and/or pipeline value, a further step in this embodiment can be managing the flow of an additional lead into the sales force based upon the pipeline value such as restricting or increasing the flow of leads into the pipeline. As more and more leads are permitted to enter the sales pipeline, an overall picture begins to develop and the present embodiment begins to let the user assess each individual sales lead as well as all the sales leads. From this view and the calculation of the various values, the system can perform the step of dynamically adjusting the flow of leads into the sales pipeline based upon an actual value. Leads flows are adjusted by messaging the different stakeholders in the lead/opportunity generation process to increase or decrease their activities and/or produce a new output result.

In accordance with another embodiment of the present invention, a computer readable medium containing executable code for optimizing the productivity of a sales force includes assigning a base value to a lead in a sales pipeline, assigning a stage value to the lead based upon a current stage of the lead in the sales pipeline, determining a pipeline stage value on the lead based upon the base and stage value and determining a pipeline value based upon the pipeline stage value of all leads/opportunities. The computer readable medium can further include determining an effective pipeline value for the pipeline stage value by assessing it with an influencing factor, which can be but not limited to the close the percentage, days to close, the opportunity value and quota attainment.

The influencing factor is assessed against the pipeline stage value and/or pipeline value by performing a mathematical operation on the pipeline stage value and/or pipeline value with the influencing factor. The mathematical function can include but not limited to multiplication and division.

The determining the pipeline stage value includes multiplying the base value by the stage value. From this pipeline stage value, the sales pipeline can be dynamically managed to ensure that the leads and resources are used efficiently and effectively. The determining the pipeline value includes summing pipeline stage value of all leads/opportunities. From this pipeline value, the sales pipeline can also be dynamically managed to ensure that the leads and resources are used efficiently and effectively.

In accordance with another embodiment of the present invention, an apparatus for optimizing and managing sales leads includes a base value generator that adds a base value to a lead in a sales pipeline, a stage value generator that adds a stage value to the lead based upon a current stage of the lead in the sales pipeline, a pipeline stage generator, linked to the base value generator and stage value generator, that generates a pipeline stage value on the lead based upon the base and stage value and a pipeline value generator that generates a pipeline value based upon the pipeline stage value of leads and opportunities in the pipeline. This apparatus can further include a pipeline regulator that dynamically adjusts the flow of pipeline resources into the sales pipelines.

In accordance with another embodiment of the present invention, an apparatus for optimizing and managing sales leads includes a pipeline calculator that assesses a value of a sales pipeline based upon at least one factor and a pipeline regulator that dynamically adjusts the flow of resources into the sales pipeline based upon the value. This alternate embodiment can further include a pipeline calibrator that is linked to the pipeline regulator.

In accordance with yet another embodiment of the present invention, a system for optimizing the productivity of a sales force includes means for assigning a base value to a lead and/or opportunity in a sales pipeline, means for assigning a stage value to the lead based upon a current stage of the lead in the sales pipeline, means for determining a pipeline stage value on the lead based upon the base and stage value and means for determining a pipeline value based on the pipeline stage value of all leads and/or opportunities in the pipeline. The system can further include means for determining an effective pipeline value for the pipeline stage value by assessing it with an influencing factor, which can be but not limited to a close percentage, days to close and the opportunity value.

The means for assessing the pipeline stage value can include means for performing a mathematical operation on the pipeline stage value with the influencing factor. The mathematical function can be multiplication or division. The means for determining the pipeline stage value includes multiplying the base value by the stage value.

The means for assessing the pipeline value can include means for performing a mathematical operation on the pipeline value with the influencing factor. The mathematical function can be summation, multiplication or division. The means for determining the pipeline value includes the sum of pipeline stage value for all leads and/or opportunities that exist in a specific pipeline.

This embodiment can further include means for managing the flow of an additional lead into the sales force based upon the pipeline stage value and/or pipeline value. The means for managing the flow can include means for restricting or increasing the flow of the additional leads and related lead generation activities based upon the pipeline stage value, pipeline value and or effective pipeline value.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a graphical representation of a sales lead as it would progress through the different stages of a sales pipeline and the time required to process complete each stage.

FIG. 2 is a chart that illustrates a scenario of a pipeline calculator in accordance with one embodiment of the present invention.

FIG. 3 is a chart that illustrates another scenario of a pipeline calculator in accordance with one embodiment of the present invention.

FIG. 4 is a chart that illustrates another scenario of a regional pipeline calculator in accordance with one embodiment of the present invention.

FIG. 5 is a diagram of a pipeline regulator in accordance with one embodiment of the present invention.

FIG. 6 is a diagram of a regional pipeline regulator in accordance with one embodiment of the present invention.

FIG. 7 is an illustration of a pipeline calibrator in accordance with one embodiment of the present invention.

FIG. 8 is an illustration of the logical flows of sales leads as implemented in accordance with one embodiment of the present invention.

### DETAILED DESCRIPTION

The invention will now be described with reference to the drawing figures, in which like reference numerals refer to like parts throughout. An embodiment in accordance with the present invention provides a method and apparatus that assesses the value of a sales pipeline based on such factors as pipeline stage and base value. From these assessments, overall decisions can be made to efficiently and effectively manage the flow of new leads, marketing activities and resources assigned to generate these leads. This embodiment also enables a sales force to efficiently utilize its resources in dealing with leads, which could result in revenue for the company.

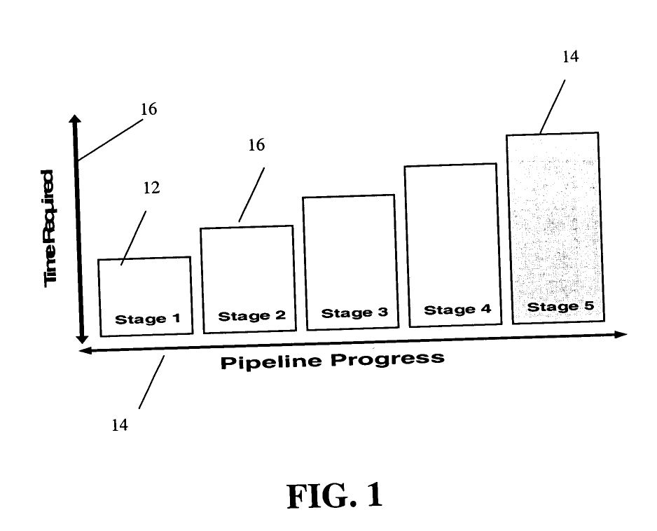

An embodiment of the present inventive apparatus and method is illustrated in FIG. 1. FIG. 1 is a graphical representation of a sales lead as it progresses through a sales pipeline and the time required to progress through each pipeline stage.

The x-axis 10 of FIG. 1 represents the stages from the initial stage, stage one 12 up until stage five 14. The y-axis 16 of FIG. 1 represents the amount of time that is generally required to deal with a sales lead in each stage of the pipeline progress. The over-arching message of FIG. 1 is that each stage requires a specific amount of time to complete the tasks of that stage before the lead and/or opportunity progresses to the next stage. Naturally, the volume of opportunities and time requirements of each stage is directly proportional to the amount of capacity required to work the pipeline effectively. Thus, the actual number of leads and/or opportunities that exist in a sales pipeline and their respective stages can be used to access the available capacity for new leads to enter the sales pipeline.

In most enterprises, pipelines are segmented into stages or phases to represent progress towards a closed sale. As a lead progresses further into the sales pipeline, it naturally deserves more attention and generally requires a greater amount of time from the sales representative as illustrated in FIG. 1. Thus, the number of leads or opportunities being worked, as well as their stage in the sales process, has a direct impact on a sales representative's ability and capacity to work new leads entering into the sales pipeline without endangering the focus needed to effectively work opportunities that are about to close.

The time required in each stage, as represented in FIG. 1, is based upon an average time required. For example, in stage one 12, there is some very initial work down such as the name of the company and the contact at the company to whom a potential sale might be made. At stage one 12, this information is initially gathered to make an initial determination as to the potentiality.

At stage two 16, the salesperson begins to devote more and more of his time, in turn more resources, in an attempt to solidify the lead. Stage two 16 can consist of educating the lead on the company's products as well as assessing the lead's need as to the potential products they might require.

During each of these stages, almost anything can happen. It is possible that the lead or opportunity will not lead to any meaningful sales after stage one 12 or any of the remaining stages. In fact, it likely that a number of the leads will not turn into sales. FIG. 1 illustrates a lead or opportunity that has made it through all the stages and the amount of time or capacity required to manage the lead.

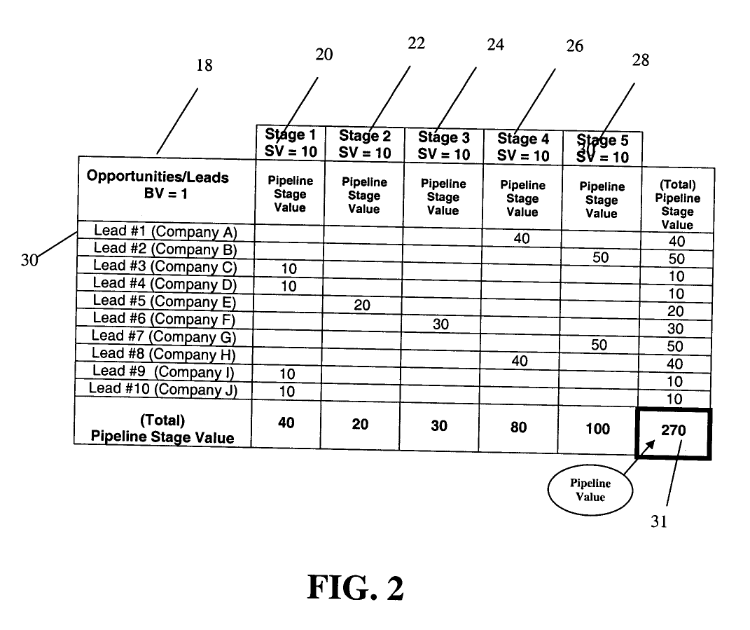

FIG. 2 is a chart that illustrates a scenario of a pipeline calculator in accordance with one embodiment of the present invention. In accordance with the preferred embodiment, FIG. 2 provides the sales department with a chart that details all of the leads and/or opportunities 18 within a sales pipeline. The first column lists all the opportunities 18 that are currently in the sales pipeline.

In this particular sales pipeline, there are five stages 20, 22, 24, 26, 28. As in FIG. 1, each of the five stages 20, 22, 24, 26, 28 represents the current status or progression of the leads 18. From the chart, Lead #1 30 is currently in the fourth of five stages of the sales pipeline. In this embodiment, this most likely means that the lead has survived the previous stages and is likely to hit. At this point, the sales manager can make a number of decisions. The sales manager might decide to provide additional resources to the sales person interacting with Lead #1 30 or give the sales person additional leads because the leads has progressed so far into the process it will terminate soon leaving the sales person available for additional work.

FIG. 2 also assesses each stage with a value. In the preferred embodiment, stage one 20 assesses each lead and/or opportunity with a value of ten points. Stage two 22 assesses each lead and/or opportunity with a value of twenty points. Stage three 24 assesses each lead and/or opportunity with a value of thirty points. Stage four 26 assesses each lead and/or opportunity with a value of forty points. Stage five 28 assesses each lead and/or opportunity with a value of fifty points.

In the preferred embodiment, the point system enables a sales manger to look at the overall status of the pipeline, as well as the status of stages. In FIG. 2, stage one 20 has four prospects in the stage for a total of forty points. Stage two 22 has one prospect in the stage for a total of twenty points. Stage three 24 has one prospect for a total of thirty points. Stage five 28 has two prospects for a total of one hundred points. The total on the points (the pipeline value) are two hundred and seventy. In the preferred embodiment, this represents a full and balanced pipeline. As a result, this value may restrict the flow of additional leads and marketing support. When this occurs, marketing is alerted to reduce leads entering into this specific pipeline. Such an action then reduces expenditures on leads that cannot be handled. Therefore, the invention has a dual effect of reducing resources, activities and allocated to attain new sales leads and managing the capacity required to work leads and/or opportunities efficiently and effectively once they enter the sales pipeline.

The total value number (pipeline value) aids the sales department in being able to get the bigger picture of the overall pipeline status. It is from this picture that a total value 31 is derived. The total value 31 helps the sales department assess whether it can handle additional leads or opportunities. Each sales department's total value 31 number to begin restriction on the leads is dependent upon the department's resources. For large sales forces, it is possible for the total value number 31 in which restriction of the sales lead is begun, to well exceed the preferred embodiment's limit of two hundred and seventy. On the other hand, for smaller sales forces, it is possible for the total value number 31 in which restriction of the sales lead is begun, to be below the preferred embodiment's limit of two-hundred and seventy. The total value 31 can independently set for each sales force. The overall effect of looking to the total value 31 is that it dynamically aids a sales department in efficiently and effectively managing existing leads as well as new leads.

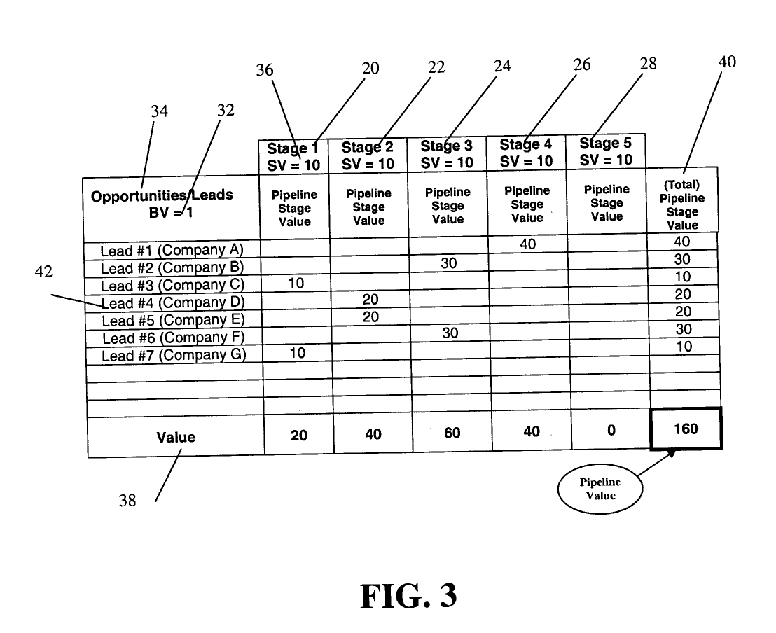

FIG. 3 is a chart that illustrates another scenario of a pipeline calculator in accordance with one embodiment of the present invention. FIG. 3 may represent a light and an unbalanced pipeline that is to receive additional marketing support through increased leads and qualified opportunities.

The pipeline calculators are algorithms used to assess the availability of a pipeline. In the preferred embodiment, the pipeline algorithm assesses or gives a base value to all new leads or opportunities 34 that enter the sales pipeline. In FIG. 3, the base value given to each new lead is one. Each stage 20, 22, 24, 26, 28 is given a stage value 36. In this embodiment, the stage value is ten points, which is the same for each stage.

As each lead or opportunity 34 moves through the pipeline, the lead and/or opportunity's pipeline stage value is calculated by multiplying the base value 32 by the stage value 36. The total stage value 38 is calculated as the sum of all the pipeline stage values. The pipeline value is the sum of all the total stage values.

In the preferred embodiment, most enterprises or sales departments will choose to manage the flow of leads into the pipelines based upon the pipeline values 40 alone. However, some enterprises may want to employ pipeline calculators that take into consideration influencing factors such as closing rates, days to close, quota attainment or monetary value of the potential sale. As with the pipeline values 40, an effective pipeline value can be used to constrict or increase the flow of new leads into the pipeline.

The effective pipeline value is calculated by performing a mathematical function on the pipeline value 40 with an influencing factor. The mathematical functions in the preferred embodiment are multiplication or division. The influencing factor can be the close percentage, days to close quota attainment and/or the opportunity dollar value.

Referring to FIG. 3, the base value for each lead 34 is one and the stage value for stage one 20 is ten, stage two 22 is twenty, stage three 24 is thirty, stage four 26 is forty and stage five 28 is fifty. As an example, the pipeline stage value to Lead #4 42 is twenty (the base value (one) multiplied by the stage value (twenty)).

If, as in the preferred embodiment, the sales department has set the restriction of the sales leads into the pipelines at two-hundred and seventy, then the pipe calculator, detailed in FIG. 3, alerts the marketing department that there is room for additional leads to be worked. At this point, additional leads are allowed to enter the pipeline. The leads are generally allocated to those pipelines where capacity is available. In referring back to FIG. 3, the pipeline of Lead #3 and Lead #7 are most likely available to handle any additional leads that enter the sales pipeline.

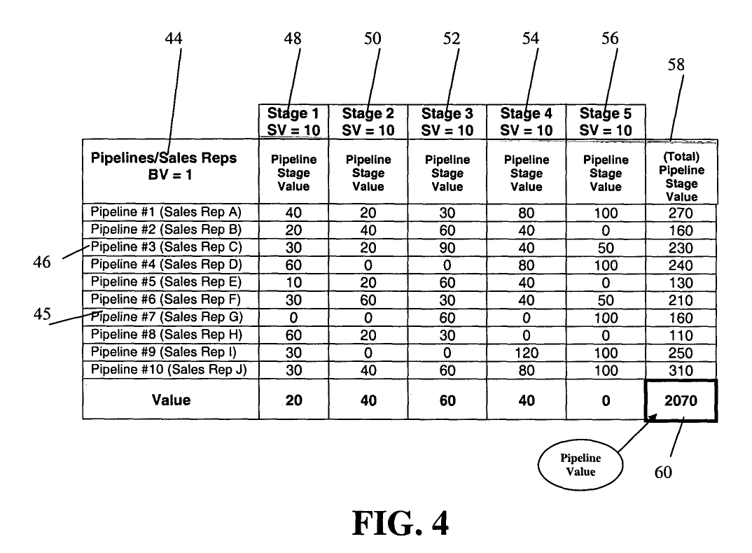

FIG. 4 is a chart that illustrates a scenario of a regional pipeline calculator in accordance with one embodiment of the present invention. In this figure, each pipeline/sales rep 44 is the pipeline of an individual sales representative such as pipeline #3 46, which is Sales Rep C. The pipeline calculator discloses the assessed values of all leads and/or opportunities that that Sales Rep C is currently interacting. In this figure, there are five stages 48, 50, 52, 54, 56. In stage one 48, Sales Rep C has a pipeline stage value of thirty. In stage two 50, Sales Rep C has a pipeline stage value of twenty. In stage three 52, Sales Rep C has a pipeline stage value of ninety. In stage four 54, Sales Rep C has a pipeline stage value of forty. In stage five 56, Sales Rep C has a pipeline stage value of fifty. The total pipeline stage value 58 for Sales Rep C is two hundred and thirty. According to the previous charts, this individual sales rep, Sales Rep C, has additional time available to handle another lead. This is based upon a total pipeline value of two hundred and seventy.

FIG. 4, in addition, to calculating the pipeline stage values for the individual sales reps, the pipeline calculator also calculates the pipeline value for a sales region. In this particular example, the total pipeline value 60 is two thousand and seventy. From this number, the regional sales department assesses the need and/or space available to handle the leads. If the value is above or at the preset limit, then marketing is notified that this particular region cannot handle additional leads and/or opportunities at this time. If the value is below the preset limit, then marketing is also notified of the need or availability for more leads and/or opportunities.

Looking to FIG. 4, if a company was to assess a two hundred and seventy limit per sales rep, then the current availability in the regional calculator is two thousand and seven hundred. Based upon the pipeline value 60 of two thousand and seventy, there is currently availability for additional leads and/or opportunities for this region. In the preferred embodiment, the appropriate department, such as marketing, is alerted to this need.

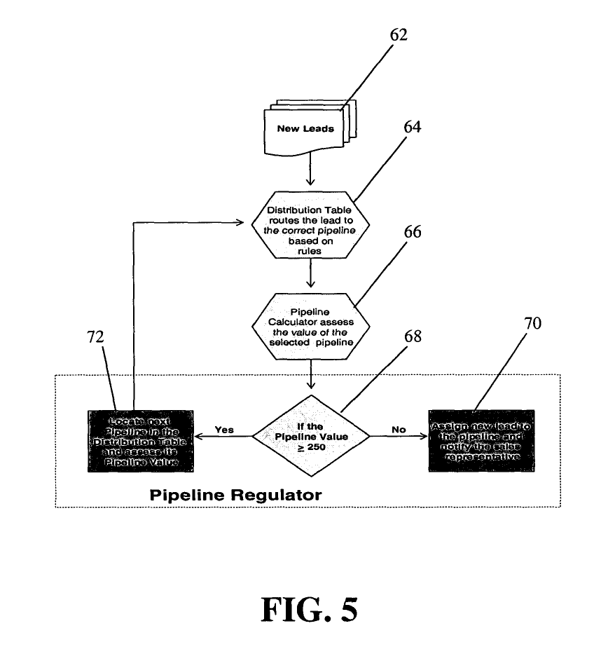

FIG. 5 is a diagram of a pipeline regulator in accordance with one embodiment of the present invention. The pipeline regulator is a rules-based engine that dynamically increases or restricts a flow of pipeline resources (market channels, campaigns, leads or opportunities) into a pipeline through triggers that are based on pipeline values or effective pipeline values. Using pipeline values that have been dynamically calculated by the pipeline calculator and pre-configured rules that have been programmed into the pipeline regulator, enterprise management can dynamically balance the flow of new leads, qualified opportunities and other marketing support against a pipeline's capacity to effectively work new leads and the overall performance of that pipeline. The pipeline regulator is also configured to re-route leads and opportunities to other pipelines that have the available capacity to accept and work new leads effectively. FIG. 5 is an illustration of how the pipeline regulator balances and routes new leads based on the pipeline's value or effective pipeline value.

While the pipeline regulator can be configured with numerous rules and conditions, there are four elements that usually exist in this rules-based engine. The elements are first, a pipeline regulator that dynamically increases or restricts the flow of pipeline resources (i.e. marketing channels, campaigns, leads, opportunities) based on the pipeline value or effective pipeline value of a specific pipeline. The second element is that the pipeline regulator messages all process stakeholders (i.e. marketing department, ad agency, tele-services group, list providers) to increase or decrease their respective resources, activities and output based on the value of specific pipelines. The third element is that the pipeline regulator continuously returns to the lead distribution table until it locates a pipeline and a sales representative that has the capacity to accept new lead. The fourth element is that the pipeline regulator has a monitoring rule that continuously and repetitively calculates and evaluates the pipeline values of all pipelines.

In referring to FIG. 5, new leads 62 are entered into the sales system. The next step 64 is a distribution table routing the lead to the correct pipeline based upon a set of rules, which are set up prior to the leads 62 entering into the sales system. The next step 68 is that the pipeline calculator assesses the value of the selected pipeline. For example, a pipeline can be but not limited to an individual sales person, complete sales force, product line and or business unit.

Referring back to FIG. 4, each lead is placed in an individual pipeline, which in this case represents an individual sales person. The pipeline stage value for Lead #1 in FIG. 3 is forty. However, the overall pipeline value for the particular pipeline is one hundred and sixty. Therefore, at pipeline calculator step 66 in FIG. 5, the pipeline calculator would return a value of one hundred and sixty for the individual pipeline disclosed in FIG. 3.

Prior to the calculation being determined, a rule was created for an overall pipeline value of two hundred and fifty. The next step 68 in FIG. 5 then determines if the calculated pipeline exceeds the preset limit of two hundred and fifty. If the determination is no, the next step 70 assigns the new lead to the pipeline and then notifies the sales representative of the new lead being added to their pipeline.

If the value does exceed the preset limit of two hundred and fifty, the next step 72 is to locate the next pipeline in the distribution table and assess its pipeline value and make a determination of whether there is sufficient space available in the alternate pipeline to accept the new lead. Referring to FIG. 4, the pipeline of Pipeline #3 46 and Pipeline #7 45 are most likely available to handle any additional leads that enter the sales pipeline.

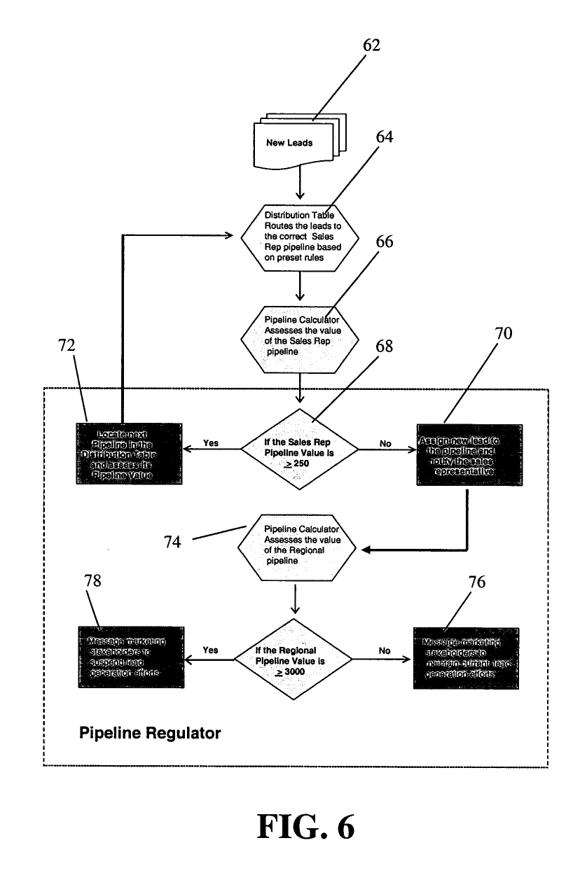

FIG. 6 is a diagram of a regional pipeline regulator in accordance with one embodiment of the present invention. In this figure, the pipeline regulator assesses the availability of a total sales force, such as a region or product. As in FIG. 5, new leads 62 are entered into the sales system. The next step 64 is that a distribution table routes the lead to the correct pipeline (Sales Rep) based upon a set of rules, which are set up prior to the leads 62 entering into the sales system. The next step 68 is that the pipeline calculator assesses the value of the selected pipeline.

The next step 68 in FIG. 6 then determines if the calculated pipeline exceeds the preset limit of two hundred and fifty. If the determination is no, the next step 70 assigns the new lead to the pipeline and then notifies the sales representative of the new lead being added to their pipeline. If the determination is yes, the next step 72 is to locate the next pipeline in the distribution table and assess its pipeline value and make a determination of whether there is sufficient space available in the alternate pipeline to accept the new lead.

If the new lead is assigned to the pipeline, then the next step 74 is that the pipeline calculator assesses the value of the regional calculator. A determination is then made based upon preset rules. The regional sales department, in this example, set the regional pipeline value at three thousand. If the determination is that the pipeline value is less than this, the next step 76 is that a message is transmitted to marketing stakeholders to maintain current lead generation efforts. If the determination is that the pipeline value is greater than three thousand, the next step 78 is that a message is transmitted to marketing stakeholders to suspend lead generation efforts.

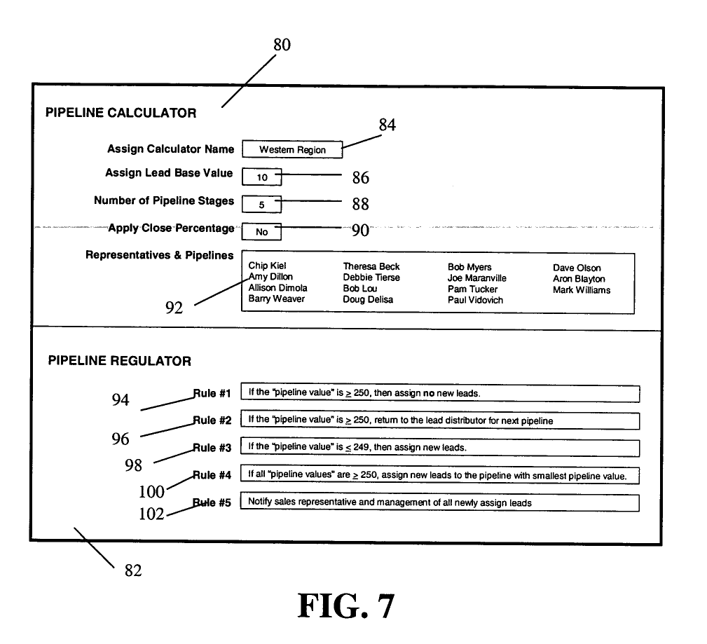

FIG. 7 is an illustration of a pipeline calibrator in accordance with one embodiment of the present invention. The pipeline calibrator is an interface that allows the user to view the performance of all pipelines, as well as create, edit, and manage all pipeline calculators and regulators. As the business climate changes or as enterprise objectives are modified, management may have the need to calibrate the pipeline calculator or the pipeline regulator. The pipeline calibrator permits management to adjust pipeline calculators and their regulators with relative ease. These adjustments are immediate and applied to all leads entering the specified pipelines.

FIG. 7 is a pipeline calibrator 56 that is portioned into two sections, a pipeline calculator 80 and a pipeline regulator 82. In the preferred embodiment, the interface for the pipeline calculator 80 includes but is not limited to a calculator name 84, a base value 86, number of pipeline stages 88, application of a close percentage 90 and the sales representatives and pipelines 92.

In this example, the sales force has fifteen available pipelines, which is equivalent to the fifteen representatives. Each of these representatives are in the Western Region and are given 10 base value points for each lead that enters into their pipeline. There are five stages from the time the lead enters the stage until the lead is brought to fruition. In this specific example, there are no influencing factors such as close percentage so the sales department is essentially managing the flow of leads based upon the pipeline value and not on an effective pipeline value.

Each of the fifteen pipelines are then regulated with the pipeline regulator 82, which is a set of rules used to manage the flow of leads into an individual pipeline. In the preferred embodiment, there are five rules 94, 96, 98, 100, 102. The first rule 94 is to check the pipeline value before assigning a lead to a pipeline. If the pipeline value is greater than 249, then the lead is not assigned to that particular pipeline. Rule two 96 then instructs the lead to check the lead distribution table for the next pipeline. Rule three 98 instructs the lead to be assigned to a pipeline if the pipeline value is less than 250. Rule four 100 states that if all the pipeline values are greater than 249, then the leads are assigned to the pipeline with the smallest pipeline value. Rule five 102 then instructs the system to notify the sales representative and management of all newly assigned leads.

The number of rules is not limited to that disclosed in the preferred embodiment. The creation of the rules is driven by the needs of each sales force. Therefore, it is possible that each sales force might have a completely different set of rules in order to effectively and efficiently manage their leads.

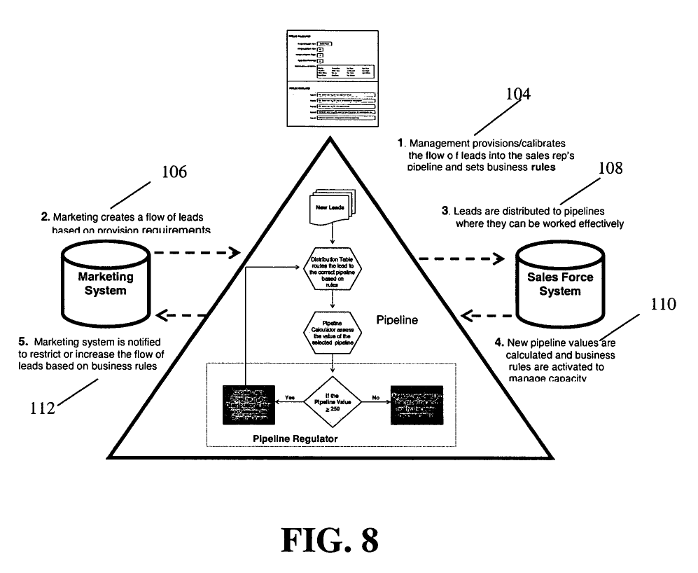

FIG. 8 is an illustration of the logical flows of sales leads as implemented in accordance with one embodiment of the present invention. Referring to FIG. 6, which is an overall summary of the present invention, the first step 104 is management provisioning or calibrating the flow of leads into the sales representative's pipeline and setting the business rules for the flow. The next step 106 is that of marketing creating a flow of leads based upon provision requirements. The leads are distributed to the pipelines where they can be worked effectively in the next step 108. New pipeline values are calculated and business rules are activated to manage capacity in the next step 110. From these pipeline values, marketing, in the next step 112, is notified to restrict or increase the flow of leads and lead generation activities based upon the business rules.

Balancing the flow of new sales leads against the capacity and effectiveness of a sales representative's pipeline allows enterprises to better manage sales & marketing resources. FIG. 8 illustrates the logical flows of leads when they have been regulated against pipeline values, which were dynamically assessed by a pipeline calculator. Enterprises who move to install pipeline calculators and pipeline regulators gain a competitive advantage in eliminating wasted marketing dollars by making sure that new leads go to the pipelines of sales representatives who can work them effectively, as well as adapting to influencing factors (such a quota attainment) to ensure that sales pipelines receive the correct supply of leads and/or opportunities needed for quotas and sales objectives to be achieved. Additionally, pipeline calibrators provide enterprise management with the functionality to dial-up or dial-down the flow of leads into pipelines. As in the practice of supply chain management, enterprise managers now how the tools to intelligently provision sales pipelines with a balanced supply of leads and opportunities, as well replenish pipelines based lead inventory levels, sales performance and available capacity.

The overall invention allows an organization to regulate lead flows and marketing activities in relation to how well the business or pipeline is doing against plan or quota. This is done through determining the pipeline value for all of the pipelines in the system as well as the overall sales pipeline value. Based on the values, the pipelines dynamically replenish the sales pipelines with leads and opportunities based on actual closed business (quota attainment). This essentially creates a self-healing or adaptive sales pipeline. In other words, if leads and/or opportunities are needed, then a message is transmitted to the effect. If leads and/or opportunities are not needed, then a message is transmitted to the effect.

In an alternate embodiment of the present invention, the above invention is performed with a computer processing device and implemented with computer software. The various determinations of the values (i.e. base, stage, pipeline) are all automatically generated by the computing device upon entry of the lead and/or opportunity into the system. The rules are preselected and perform their function upon a lead and/or opportunity is entered into the system. The invention is programmed into a software language such as C to which executable code is generated to activate the invention.

An additional aspect of the preferred embodiment is that it can track history of events such as the cycle time experienced to deliver leads to a pipeline, the close rates experienced per pipeline, the time it takes to move from stage to stage per pipeline, the actual historical probability of moving from stage to stage (i.e. one sale rep may lose a greater number of leads in stage three than the average sales rep).

A further aspect of the invention is the invention's ability to predict anticipated need of the pipeline. For example, a salesman, who has a full pipeline, has a territory that takes an additional week lead time to get leads generated because of his current location. In this example, the preferred embodiment would anticipate this need and start to passing leads through the pipeline taken into account this lag time.

Another example is a sales rep that has eight leads in stage three and one in stage five. His historical record dictates that he has a better record of closing stage five leads than stage three leads. In fact, his stage three losses are greater than the average sales rep. The preferred embodiment predicts this scenario and adjusts accordingly.

The many features and advantages of the invention are apparent from the detailed specification, and thus, it is intended by the appended claims to cover all such features and advantages of the invention, which falls within the true spirit, and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method for optimizing the productivity of a sales force, comprising:
assigning a base value to a lead in a sales pipeline;
assigning a stage value to the lead based upon a current stage of the lead in the sales pipeline; and
determining a pipeline stage value on the lead based upon the base and stage value.

2. The method as in claim 1, further comprising determining an effective pipeline value for the pipeline stage value by assessing it with an influencing factor.

3. The method as in claim 2, wherein the influencing factor is selected from the group consisting of a close percentage, days to close, quota attainment and monetary value of an opportunity or group of opportunities.

4. The method as in claim 2, wherein the assessing the pipeline stage value comprises performing a mathematical operation on the pipeline stage value with the influencing factor.

5. The method as in claim 4, wherein the mathematical function selected from the group consisting of summation, multiplication and division.

6. The method as in claim 1, wherein the determining the pipeline stage value comprises multiplying the base value by the stage value.

7. The method as in claim 1, further comprising managing the flow of an additional lead into the sales force based upon a pipeline value.

8. The method as in claim 7, wherein the managing the flow comprises restricting the flow of the additional lead based upon the pipeline value.

9. The method as in claim 7, wherein the managing the flow comprises increasing the flow of the additional based upon the pipeline value.

10. The method as in claim 2, further comprising managing the flow of an additional lead into the sales force based upon the effective pipeline value.

11. The method as in claim 1, further comprising assigning pipeline stage value to another lead that enters the sales force.

12. The method as in claim 11, further comprising determining a total stage value for each stage of a sales pipeline.

13. The method as in claim 12, further comprising determining a pipeline value based upon the total stage value.

14. The method as in claim 13, further comprising determining an effective pipeline value.

15. The method as in claim 14, wherein the effective pipeline value is determined by assessing the pipeline stage value with an influencing factor.

16. The method as in claim 15, wherein the influencing factor is selected from the group consisting of a close percentage, days to close, quota attainment and monetary value of an opportunity or group of opportunities.

17. The method as in claim 15, wherein the assessing the pipeline stage value comprises performing a mathematical operation on the pipeline stage value with the influencing factor.

18. The method as in claim 17, wherein the mathematical function is selected from the group consisting of summation, multiplication and division.

19. The method as in claim 1, dynamically adjusting the flow of leads into the sales pipeline based upon an actual value.

20. The method as in claim 19, wherein adjusting is selected from the group consisting of restricting and increasing based upon the actual value.

21. The method as in claim 19, wherein adjusting is comprised of re-routing the lead to other pipelines.

22. The method as in claim 1, further comprising determining a pipeline value for the sales pipeline.

23. The method as in claim 22, further managing leads in the sales pipeline based upon the pipeline value.

24. The method as in claim 22, further comprising regulating other stakeholders.

25. The method as in claim 22, further comprising regulating other activities.

26. The method as in claim 24, wherein the stakeholders is selected from the group consisting of ad agencies, marketing departments, list companies, database companies and teleservices.

27. A computer readable medium containing executable code for optimizing the productivity of a sales force, comprising:
assigning a base value to a lead in a sales pipeline;
assigning a stage value to the lead based upon a current stage of the lead in the sales pipeline; and
determining a pipeline stage value on the lead based upon the base and stage value.

28. The computer readable medium as in claim 27, further comprising determining an effective pipeline value for the pipeline stage value by assessing it with an influencing factor.

29. The computer readable medium as in claim 28, wherein the influencing factor is selected from the group consisting of a close percentage, days to close quota attainment, and monetary value of an opportunity or group of opportunities.

30. The computer readable medium as in claim 28,wherein the assessing the pipeline stage value comprises performing a mathematical operation on the pipeline stage value with the influencing factor.

31. The computer readable medium as in claim 30, wherein the mathematical function is selected from the group consisting of multiplication, division and summation.

32. The computer readable medium as in claim 27, wherein the determining the pipeline stage value comprises multiplying the base value by the stage value.

33. The computer readable medium as in claim 27, further comprising managing the flow of an additional lead into the sales force based upon the pipeline stage value.

34. The computer readable medium as in claim 33, wherein the managing the flow is selected from the group consisting of increasing and restricting the flow of the additional lead based upon the pipeline stage value.

35. The computer readable medium as in claim 28, further comprising managing the flow of an additional lead into the sales force based upon the effective pipeline value.

36. The computer readable medium as in claim 27, further comprising assigning pipeline stage value to another lead that enters the sales force.

37. The computer readable medium as in claim 36, further comprising determining a total stage value for each stage of a sales pipeline.

38. The computer readable medium as in claim 37, further comprising determining a pipeline value based upon the total stage value.

39. The computer readable medium as in claim 38, further comprising determining an effective pipeline value.

40. The computer readable medium as in claim 39, wherein the effective pipeline value is determined by assessing the pipeline stage value with an influencing factor.

41. The computer readable medium as in claim 40, wherein the influencing factor is selected from the group consisting of a close percentage, days to close, quota attainment and opportunity value.

42. The computer readable medium as in claim 39,wherein the assessing the pipeline stage value comprises performing a mathematical operation on the pipeline stage value with the influencing factor.

43. The computer readable medium as in claim 42, wherein the mathematical function is selected from the group consisting of multiplication, division and summation.

44. The computer readable medium as in claim 27, dynamically adjusting the flow of leads into the sales pipeline based upon an actual value.

45. The computer readable medium as in claim 44, wherein adjusting is selected from the group consisting of increasing and restricting the flow of leads based upon the actual value.

46. The computer readable medium as in claim 44, wherein adjusting is comprised of re-routing the lead to other pipelines.

47. The computer readable medium as in claim 27, further comprising determining a pipeline value for the sales pipeline.

48. The computer readable medium as in claim 47, further comprising managing leads in the sales pipeline based upon the pipeline value.

49. The computer readable medium as in claim 47, further comprising regulating other stakeholders based upon the pipeline value.

50. The computer readable medium as in claim 47, further comprising regulating other activities based upon the pipeline value.

51. The computer readable medium as in claim 49, wherein the stakeholders is selected from the group consisting of ad agencies, marketing departments, list companies, database companies and teleservices.

52. An apparatus for optimizing and managing sales leads, comprising:
a base value generator that adds a base value to a lead in a sales pipeline;
a stage value generator that adds a stage value to the lead based upon a current stage of the lead in the sales pipeline; and
a pipeline stage value generator, linked to the base value generator and stage value generator, that generates a pipeline stage value on the lead based upon the base and stage value.

53. The apparatus as in claim 52, further comprising a pipeline regulator that dynamically adjust the flow of pipeline resources into the sales pipelines.

54. An apparatus for optimizing and managing sales leads, comprising:
a pipeline calculator that assess a value to a lead into a sales pipeline based upon at least one factor; and
a pipeline regulator that dynamically adjusts the flow of resources into the sales pipeline based upon the value.

55. The apparatus as in claim 51, further comprising a pipeline calibrator that is linked to the pipeline regulator.

56. A system for optimizing the productivity of a sales force, comprising:
means for assigning a base value to a lead in a sales pipeline;
means for assigning a stage value to the lead based upon a current stage of the lead in the sales pipeline; and
means for determining a pipeline stage value on the lead based upon the base and stage value.

57. The system as in claim 56, further comprising means for determining an effective pipeline value for the pipeline stage value by assessing it with an influencing factor.

58. The system as in claim 57, wherein the influencing factor is selected from the group consisting of a close percentage, days to close, quota attainments and opportunity value.

59. The system as in claim 57,wherein the means for assessing the pipeline stage value comprises means for performing a mathematical operation on the pipeline stage value with the influencing factor.

60. The system as in claim 59, wherein the mathematical function is selected from the group consisting of multiplication, division and summation.

61. The system as in claim 53, wherein the means for determining the pipeline stage value comprises multiplying the base value by the stage value.

62. The system as in claim 56, further comprising means for managing the flow of an additional lead into the sales force based upon the pipeline stage value.

63. The system as in claim 62, wherein the means for managing the flow comprises means for restricting the flow of the additional lead based upon the pipeline stage value.

64. The system as in claim 62, wherein the means for managing the flow comprises means for increasing the flow of the additional based upon the pipeline stage value.

65. The system as in claim 57, further comprising means for managing the flow of an additional lead into the sales force based upon the effective pipeline value.

66. The system as in claim 56, further comprising means for assigning pipeline stage value to another lead that enter the sales force.

67. The system as in claim 66, further comprising means for determining a total stage value for each stage of a sales pipeline.

68. The system as in claim 67, further comprising means for determining a pipeline value based upon the total stage value.

69. The system as in claim 64, further comprising means for determining an effective pipeline value.

70. The system as in claim 69, wherein the effective pipeline value is determined by assessing the pipeline stage value with an influencing factor.

71. The system as in claim 56, further comprising means for determining a pipeline value for the sales pipeline.

72. The system as in claim 71, further comprising means for managing leads in the sales pipeline based upon the pipeline value.

73. The system as in claim 71, further comprising means for regulating other stakeholders based upon the pipeline value.

74. The system as in claim 71, further comprising means for regulating other activities based upon the pipeline value.

75. The system as in claim 73, wherein the stakeholders is selected from the group consisting of ad agencies, marketing departments, list companies, database companies and teleservices.

76. A method for regulating a sales pipeline with leads, comprising:
provisionally conveying a lead to a pipeline;
determining if the pipeline has the capacity to handle the lead; and
regulating the flow of leads into the pipeline based upon the determination.

77. The method as in claim 76, wherein the step of regulating comprises restricting the flow of leads into the sales pipeline.

78. The method as in claim 76, wherein the step of regulating comprises replenishing the flow of leads into the sales pipeline.

79. The method as in claim 77, further comprising notifying a lead generator to reduce the number of leads into the pipeline.

80. The method as in claim 79, wherein the lead generator is a marketing department.

81. The method as in claim 78, further comprising notifying a lead generator to increase the number of leads into the pipeline.

82. A method for assessing a sales pipeline comprising:
determining a pipeline value for the sales pipeline; and
managing flow of a lead into the sales pipeline bases upon the pipeline value.

83. The method as in claim 82, further comprising transmitting a message in response how the sales pipeline is managed in response to the pipeline value.

84. The method as in claim 82, further comprising tracking the historical performance of an aspect of the sales pipeline.

85. The method as in claim 82, wherein the aspect is selected from the group consisting of a sales representative performance and lead time.

86. A computer readable medium containing executable code for optimizing the productivity of a sales force, comprising:
determining a pipeline value for the sales pipeline; and
managing flow of a lead into the sales pipeline bases upon the pipeline value.

87. The computer readable medium as in claim 86, further comprising transmitting a message in response how the sales pipeline is managed in response to the pipeline value.

88. The computer readable medium as in claim 86, further comprising tracking the historical performance of an aspect of the sales pipeline.

89. The method as in claim 86, wherein the aspect is selected from the group consisting of a sales representative performance and lead time.

90. A system for assessing a sales pipeline comprising:
means for determining a pipeline value for the sales pipeline; and
means for managing flow of a lead into the sales pipeline bases upon the pipeline value.
